(19) United States
(12) Patent Application Publication
(10) Pub. No.: US 2026/0336124 A1
(43) Pub. Date: Oct. 29, 2026

(54) ROBOTIC TRANSPORT SYSTEM AND METHOD THEREFOR

(71) Applicant: Brooks Automation US, LLC, Chelmsford, MA (US)

(72) Inventors: Prasad Nair, Richmond, CA (US); Tim DeRosett, Oregon City, OR (US); Dimitri Kambouridis, Oakland, CA (US); Jay Calvin Nelson, II, Grapevine, TX (US); Ivaylo Velinov, Brentwood, CA (US); Brian Carlisle, Los Altos, CA (US); Dalton P. Dodge, Freemont, CA (US)

(73) Assignee: Brooks Automation US, LLC, Chelmsford, MA (US)

(21) Appl. No.: 19/107,980

(22) PCT Filed: Sep. 4, 2024
(86) PCT No.: PCT/US2024/045098

§ 371 Date: Feb. 28, 2025

Related U.S. Application Data
(60) Provisional application No. 63/580,598, filed on Sep. 5, 2023.
(60) Provisional application No. 63/597,957, filed on Nov. 10, 2023.

(51) Int. Cl. B25J 9/16

(52) U.S. Cl. CPC B25J 9/1697; B25J 9/162; B25J 9/1633

(57) ABSTRACT

A robot is provided. In some embodiments, the robot includes a first imaging system configured to detect the presence of objects/components in the robot's workspace, and a second imaging system configured to determine the position of the objects/components relative to an end effector of the robot.

### FIELD

The present disclosure generally relates to material handling, and more particularly, to stereoscopic target identification of objects and transport of those identified objects.

### BACKGROUND

Robots may generally be used to perform a variety of tasks on objects in work environment. Generally, such robots must be manually taught the locations of such objects by a human collaborator. Such robots may then perform tasks on such objects, such as moving the objects between different locations.

### SUMMARY

In some embodiments, a robot is disclosed, the robot comprising an articulated robot arm configured to be back-driven by force applied by a human or a mating operation in a workspace of the robot arm, an end effector disposed on the robot arm, the end effector comprising a gripper configured to grip an object, a first imaging system comprising a first imager configured to capture images in a first direction, a second imaging system comprising a second imager configured to capture images in a second direction, and a controller configured to control either the first imager or the second imager to obtain a set of stereo images of a target disposed in the workspace, determine a position of the end effector relative to the target based on images of the target, wherein the images include only the set of stereo images obtained by the first imager or the second imager, to determine a position of the end effector relative to the object based at least in part on the determined position of the end effector relative to the target and on a position of the target relative to the object, and to control robot motion based on the determined position of the end effector relative to the object using images obtained only by the imager which obtained the set of stereo images.

In some embodiments, a method of controlling a robot comprising an articulated robot arm and a gripper disposed on an end effector of the robot arm is disclosed, the method comprising controlling a first imager or a second imager to obtain a set of stereo images of a target disposed in the workspace, the first imager pointing in a different direction than the second imager, determining a position of the end effector relative to the target based on images of the target, the images including only the set of stereo images obtained by the first imager or the second imager, determining a position of the end effector relative to an object based at least in part on the determined position of the end effector relative to the target and on a position of the target relative to the object, and controlling motion of the robot based on the determined position of the end effector relative to the object using images obtained only by the imager which obtained the set of stereo images, wherein the robot arm is configured to be back-driven in response to a force applied by a human or a mating operation in the workspace.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical object that is illustrated in various figures may be represented by a like numeral. For purposes of clarity, not every object may be labeled in every drawing. In the drawings:

FIG. 1 shows a perspective view of a robot according to an embodiment;

FIG. 2 shows a top view of the robot of FIG. 1;

FIG. 3 shows a top view of a plurality of robots disposed in a flexible work environment according to an embodiment;

FIG. 4 shows a lower perspective view of a robot arm according to an embodiment;

FIG. 5 shows an upper perspective view of the robot arm of FIG. 4;

FIG. 5 shows a simplified representation of a method of determining a three-dimensional position of a target according to an embodiment; and

FIG. 7 shows a method of operating a robot according to an embodiment.

### DETAILED DESCRIPTION

It should be understood that inventive features are described herein with reference to the figures, which show illustrative embodiments. The illustrative embodiments described herein are not necessarily intended to show all embodiments that incorporate all inventive features, but rather are used to describe a few illustrative embodiments and selected combinations of inventive features. Thus, inventive features are not intended to be construed narrowly in view of the illustrative embodiments. In addition, it should be understood that inventive features may be used alone or in any suitable combination with other inventive features.

Robots are often used to perform tasks in collaboration with humans in a work environment. In such a work environment, the robots and the humans may each perform various tasks on objects to produce desired deliverables (e.g. products, test results, etc.). In use, such robots are generally taught pick and place positions of an object, as well as any other movements necessary to perform tasks with the object (e.g. soldering components on a PCB, mixing ingredients in a test tube, etc.) by human collaborators, and then configured to repeat such movements with subsequent objects.

The inventors have recognized an advantage to a robot configured to automatically adjust to changes in the work environment. For instance, collaborators may wish to frequently physically reposition the robot in a workspace based on the number of robots or human collaborators available without needing to manually reteach the robot the pick and place locations. Additionally, human collaborators may place the objects imprecisely, and it may be desirable for the robot to be configured to adapt to the imprecise placing by the human collaborators.

The inventors have also recognized an advantage to a robot which is configured to automatically perform tasks on objects without requiring additional input from the collaborators. Such a configuration may improve efficiency and avoid dead time (e.g. the robot can begin work on objects as soon as they are placed in the workspace rather than waiting on input commands from collaborators).

The inventors have therefore recognized an advantage to a robot which may be configured to sense the presence of objects and/or other components (e.g. holding stations, processing stations, work benches, etc.) and to determine the position of the objects/other components relative to an end effector of the robot. The robot may then be configured to perform tasks with the objects (e.g. move objects from holding stations to processing stations or vice versa, perform work on the objects at the processing stations, etc.). Such a configuration may allow human collaborators to rapidly reconfigure the work environment without needing to manually teach locations of objects and/or other components to the robot. Such a configuration may also allow for collaborators to work collaboratively with the robot without requiring high amounts of precision from the collaborators and/or allow the robot to adapt to varying conditions such as variable format object holders and objects. Such a configuration may also allow for the automated performance of tasks with minimal input from the collaborators.

In some embodiments, the robot may include a first imaging system and a second imaging system. In some embodiments, each imaging system configured to be used by a controller to independently control movement of the robot. The first imaging system may include a first imager (e.g. a camera and image processing module such as image analysis software and associated hardware), and the second imaging system may include a second imager. The controller may be configured to control the first imager or the second imager to image the workspace and determine presence of objects and/or other components in the workspace. When an object and/or other component is detected, the controller may then control the first imager or the second imager to obtain one or more images (e.g., stereo images) of a target disposed in a predetermined position relative to the object/other component (e.g. disposed on the object/component, or adjacent to the object/component). The controller may then use these stereo images to determine the three-dimensional position of the target relative to the end effector and/or other portions of the robot. The controller may then determine the position of the objects/other components relative to the end effector based on the determined position of the end effector relative to the target and on the predetermined position of the object/component relative to the target. In some embodiments, presence of an object/component may be detected using one imaging system, while the three-dimensional position of a target disposed on the object may be determined using the other imaging system.

One potential use-case is as follows. Collaborators may position a processing station in the workspace of the robot. The robot may detect the presence of the processing station via the first imager or the second imager and learn the position of the processing station via the first imager or the second imager. The collaborators may position a first holding station containing a first set of one or more objects anywhere the workspace of the robot. The robot may detect the presence of the first holding station and the first set of objects associated with the holding station via the first imager or the second imager. The robot may determine the position of the first holding station and the first set of objects relative to the end effector of the robot via the first imager or the second imager. The robot may move an object to the processing station, perform work on the object, and move the object back to the first holding station. The robot may repeat this process for each object in the first holding station. While the robot is performing tasks on the first set of objects, the collaborators may position a second holding station in the workspace of the robot. The robot may detect the presence/position of the second holding station/second set of objects via the first and/or second imagers, and begin automatically performing tasks on the second set of objects once tasks on the first set of objects is complete. Collaborators may then move the first holding station and first set of objects to a different location for further processing, packaging, etc.

As mentioned above, the inventors have also recognized that it may be desirable for the robot to work collaboratively with humans. Such collaboration may require human collaborators to enter the workspace of the robot to perform tasks. The inventors have recognized an advantage to configuring the robot to be back-drivable, such that an external force applied by a human may stop or move the robot arm from its controlled movement trajectory. This back-drivability may allow human collaborators to push the arm out of their way without damaging the arm. This back-drivability may also allow the arm to stop if it contacts a human or other component in the workspace, limiting damage to the human, the robot, and/or the other component. In some embodiments, this back-drivability may also be used to ensure proper positioning of objects. For instance, contact between an object and an object receptacle (e.g. a slot in a holding station for receiving an object) may be used to guide the object into an object receptacle in the holding station during a mating operation.

The inventors have also recognized an advantage to configuring the robot to perform tasks in a life sciences environment. Therefore, in some embodiments, the objects may be sample holders configured to hold a material for laboratory analysis. Such a sample holder may be a life sciences sample tray, a life sciences microplate, an individual life sciences sample tube held in a tray or microplate; or any piece of life sciences labware used to hold any type of sample, such as including a liquid and/or solid material.

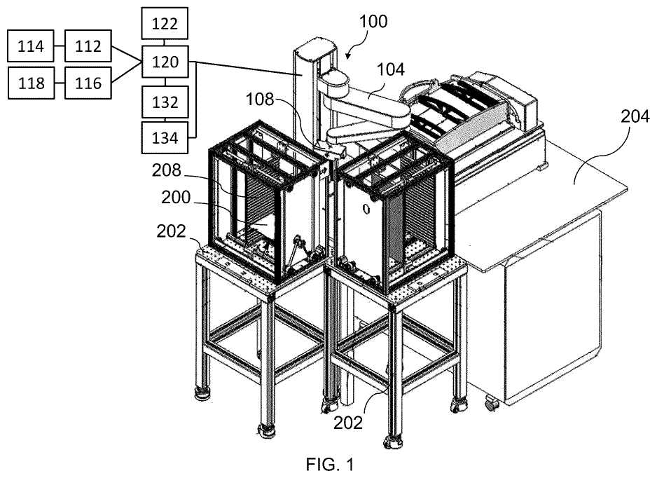

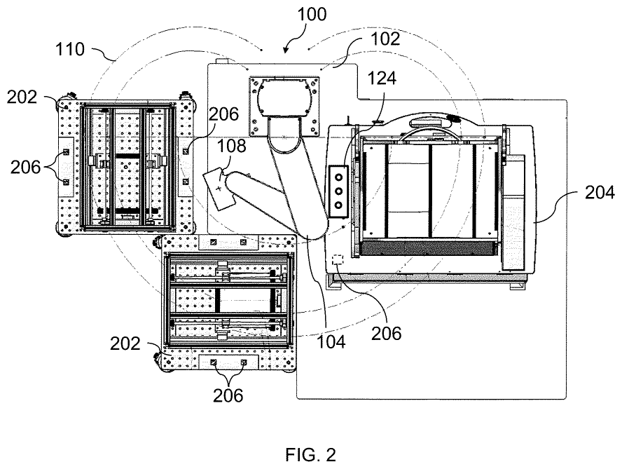

FIGS. 1 and 2 show a perspective view and a top view, respectively, of an illustrative robot 100 that incorporates one or more inventive features. The robot may include a base 102, an articulated robot arm 104, and an end effector 108 disposed at an end of the articulated robot arm. The robot 100 may include a controller 120 configured to control drive motor(s) 132 in the robot arm 104 to move the end effector 108 within the workspace 110. The robot may be configured to move objects 200 between various stations and/or perform operations on objects 200. Such stations may include holding stations 202 configured to hold a plurality of objects 200 in receptacles 208, and processing stations 204 where operations are performed on the objects 200. In some embodiments, the robot 100 may be configured to perform various operations on the objects 200 when placed at the processing station 204. Alternatively, or in addition, a human collaborator or other robot/machine may perform operations on the objects at the processing station 204.

The robot arm 104 may be any suitable type of robot arm, such as a gantry robot, a SCARA robot, a telescopic or sliding arm robot, etc. In some embodiments, as seen in FIG. 2, the processing station 204 and robot arm 104 may be mounted on the same base 102, such that the processing station 204 is always at a predetermined position relative to base 102. In other embodiments, the processing station 204 is mounted on a separate base.

As discussed above, it may be desirable for the robot to be configured to automatically detect presence of objects 200 and/or other components (e.g. holding stations 202, processing stations 204, etc.), and automatically determine a position of the end effector 108 of the robot 100 relative to the objects/other components. The robot 100 may therefore include a first imaging system 112 with a first imager 114, and a second imaging system 116 with a second imager 118. The robot 100 may also include a controller 120 configured to control the first and second imaging systems 112 and 116, and to use information from the first or second imaging system 112, 116 to control movement of the robot 100.

The controller 120 may be configured to control the imaging systems 112,116 to detect presence of objects and/or other components in the workspace 110 of the robot by imaging the workspace 110 with the imagers 114, 118. The imagers 114, 118 may be disposed in any location which allows for imaging of the workspace 110. More details on the location of the imagers 114, 118 will be discussed further below.

Once the presence of an object/component is detected, the controller 120 may be configured to use the imaging systems 112, 116 to determine the relative positioning of the end effector 108 relative to the objects/other components. Each object/component may be associated with at least one target 206 disposed at a predetermined position relative to the object/component. For instance, in some embodiments, each object 200 may include a target 206 disposed on the object 200. In some embodiments, a target 206 may be disposed adjacent to the object/component (e.g. on a receptacle 208). In some embodiments, a target 206 may be disposed on the stations 202 and/or 204, and objects 200 may be positioned at predetermined positions in the stations 202/204 relative to the target 206. For instance, in some embodiments, holding stations 202 include targets 206 disposed on a portion of holding stations 202, and include receptacles 208 configured to hold objects 200 at predetermined positions relative to the targets 206. The controller 120 may control the imaging systems 112, 116 to use the imagers 114, 118 to obtain stereo images of the target 206 using any suitable stereo imaging process, as discussed further below. The controller 120 may use these stereo images to determine the three-dimensional position of the target 206 relative to the end effector 108. The controller 120 may then determine the three-dimensional position of the object/component relative to the end effector 108 based on the determined position of the end effector relative to the target and based on the predetermined position of the target relative to the object/component. In some embodiments, a single target 206 is used to determine the position of the end effector 108 relative to the objects 200/other components. In some embodiments, multiple targets 206 or sets of targets 206 are used to determine the position of the end effector 108 relative to the objects/other components.

In some embodiments, the imaging systems 112, 116 may be used independently by the controller 120 to control movement of the robot 100. For example, the imaging systems 112, 116 may have non-overlapping fields of view and each imaging system 112, 116 may be used alone to determine the position of an object relative the robot and control subsequent movement of the robot relative to the object. For example, the imaging system 112 may be used to determine the position of the end effector 108 relative to objects within its field of view (e.g., using one or more sets of stereo images captured by the first imager 114) and the imaging system 116 may be used to determine the position of the end effector 108 relative to objects within its field of view (e.g., using one or more sets of stereo images captured by the second imager 118). Such arrangements may provide advantages in some robot and imager configurations such as where first and second imagers 114, 118 are mounted on an end effector 108 and the end effector 108 is limited in its degrees of freedom, and thus limited in how the first and second imagers 114, 118 can be oriented for imaging. For example, in some configurations a first imager 114 may only have a horizontal field of view because of limitations on the movement of the end effector, and a second imager 118 may only have a vertically oriented (e.g., downward) field of view, again because of limitations on the end effector movement and/or its degrees of freedom. However, since the first and second imagers 114, 118 can be operated to collectively determine the position of all objects in the robot's workspace, the robot can be controlled to move in relation to objects in a wide range of positions. Such arrangements may also allow the controller 120 and one of the imaging systems 112, 116 to capture stereo images while the robot 100 is being moved for other tasks, thereby avoiding dedicated movement of the end effector for purposes only of determining the location of an object. For example, while the robot is being moved based on position detection and control using information from the second imaging system 116, the first imaging system 112 may be used to capture stereo images of another object in the workspace so the controller 120 can determine the position of the object relative to the robot (e.g., the end effector 108) and use this information to later control the robot movement once the current task is completed. This may allow for more efficient operation of the robot since movement of the robot during a task may be employed to capture stereo images of an object for planning future movement operations of the robot rather than requiring movement of the end effector solely for the purpose of object detection and position determination relative to the robot.

In some embodiments, the imaging systems 112 and 116 may be integrated into the robot, attached to an end effector 108 or other robot portion. In some embodiments, the imaging system 112 and 116 may be selectively attachable/detachable, such that the imaging system 112 and 116 may be used with other robots.

As discussed above, it may be desirable for the robot 100 to perform tasks on objects 200 placed in the robot's workspace 110 without requiring additional input from human collaborators in order to reduce robot down-time and improve overall efficiency. Therefore, once the position of the objects/other components relative to the end effector 108 are determined, the controller 120 may then automatically control drive motor(s) 132 of the robot 100 to perform various tasks on the objects 200. For instance, in some embodiments, the end effector may include a gripper 122 configured to grip the objects 200 and move them between the holding stations 202 and processing stations 204. In some embodiments, the gripper 122 may also perform operations on the objects 200 at the processing stations 204. In some embodiments, the robot 100 may be equipped with a tool changer 124, and the robot 100 may be configured to move an object 200 to the processing station 204 with the gripper 122, then move to the tool changer 124, and swap the gripper 122 out for different tool (e.g. a stirring tool, a soldering tool, etc.) to perform operations on the object 200. In some embodiments, the processing station 204 itself may be configured to perform various operations on the object 200. For instance, the processing station 204 may include a centrifuge configured to spin the object 200.

In some embodiments, the robot 100 may be configured to only perform operations on an object 200 placed at a processing station 204. For instance, a human collaborator 400 or other robot may place the object 200 at the processing station, the robot may then detect the position and determine the three-dimensional position of the object 200 relative to the end effector, and perform operations on the object 200. A human collaborator 400 or other robot may then remove the object 200 from the processing station 204.

As discussed above, it may be desirable for humans to work collaboratively with the robot. Such collaborative work may require humans to enter the workspace 110. Therefore, as discussed above, it may be desirable for the robot 100 to be back-drivable to limit any injury to humans and to limit any damage to the robot 100 if collisions between the human collaborators and the robot 100 occur.

As used herein, the term “back-driven” or “back-driving” refers to the ability of an external force (such as by a human or any other object/obstacle physically engaging/contacting the arm) applied to the robot arm 104 to overcome the drive motor(s) 132 in the robot arm 104. This external force may stop the robot arm 104 from moving along its controlled trajectory, and/or may alter the trajectory of the robot arm 104. Such back-drivability may allow the robot arm 104 to stop moving if it contacts a human or other obstacle along the robot arm's controlled trajectory. It may also allow humans to manually alter the trajectory of the robot arm 104 if necessary to avoid injuries and/or damage.

In some embodiments, the inventors have also recognized an advantage to using the back-drivability of the robot arm to ensure proper “fit-up” between the objects 200 and the object receptacles 208 in the holding stations 202 during a mating operation. Contact between the object 200 and sides of the object receptacles 208 may back drive the robot arm 104 to guide the object 200 in and out of the object receptacle 208. Such a configuration may allow for correction of movement of the robot arm as necessary as a result of errors (e.g. out of tolerance objects or object receptacles, inaccurately placed targets, errors in the relative position determinations, shifting of stations during operations, etc.)

In some embodiments, the robot arm 104 may include any suitable feedback sensors 134. For instance, the robot arm 104 may include position sensors to determine and/or verify positions of each arm link relative to other arm links. The robot arm may also include force sensors configured to detect the application of an external force to the robot arm. In some embodiments, the controller 120 may be configured to reduce/remove power to the drive motor(s) 132 in response to application of an external force to the robot arm. (e.g. if a human pushes on the arm). In some embodiments, the objects 200 may be sample holders holding materials for laboratory analysis. Such sample holders may be life sciences sample trays, life sciences microplates, individual life sciences sample tubes held in a tray or microplate; or any pieces of life sciences labware. The robot may be configured to perform any suitable tasks or combination of tasks on the sample holders, such as mixing materials in the sample holders, transporting sample holders between processing stations for humans or other workers to perform work on, measuring parameters of the material in the sample holders, and/or any other tasks or combinations of tasks.

While the above embodiment discloses the robot arm performing tasks on a sample holder in a life sciences environment, it is contemplated that robot 100 may be configured to operate in any suitable work environment any perform tasks on any suitable object. For instance, the robot may be employed in a warehouse environment, a manufacturing plant (e.g. automotive, aerospace, electronics, semiconductor, etc.) or any other suitable environment. Objects 200 may be printed circuit boards, warehouse goods/containers, automotive parts, aerospace parts, electronic components, semiconductor wafers, or any other suitable object. The robot may be configured to perform any suitable tasks on such objects, such as milling, welding, soldering, etc.

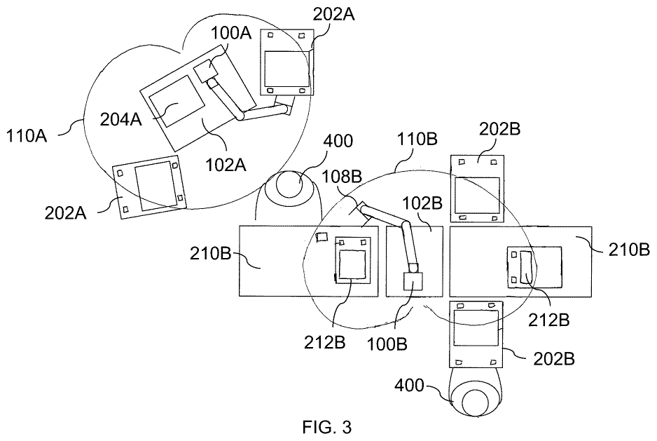

FIG. 3 shows a top view of a flexible work environment which incorporates one or more inventive features. As discussed above, in some embodiments, it may be desirable for the robot 100 to be capable of functioning in a flexible work environment. For instance, more human collaborators 400 may be available to perform a specific task on one day as compared to another. Alternatively, it may be desirable for the robot to switch between different sets of tasks depending on current demand, and such different tasks may require different positioning of the robot 100 and various objects/other components. Therefore, in some embodiments, base 102 of the robot 100 may be configured to be a moveable base (e.g. with wheels) to allow the robot 100 to be moved across a floor or other support surface. Various holding stations 202, processing stations 204, and work benches 210 may also be movable. Human collaborators 400 may position the robot 100 and various stations in any desired layout and command the robot to execute a set of defined tasks. The robot may then use the imaging systems to detect the presence and position of the various stations 202, 204, and/or 210 and any objects 200 disposed in the stations, and then automatically execute the tasks on each of the objects 200. The layouts of various robots and stations may then be altered as necessary to suit the relevant task. For instance, as seen in FIG. 3, a first robot 100A may be configured to perform task A and a second robot 100B may be configured to perform task B.

To perform task A, Robot 100A may be configured to move objects from holding stations 202A to a processing station 204A, perform work on the objects (with or without the use of a tool changer), and move the object back to the holding station 202A. Robot 100A may be configured to image its workspace 110A to detect the presence of holding stations 202A containing unprocessed objects 200A, to determine the position of the objects 200A relative to the end effector, and to perform the defined operations on each object 200A. Human collaborators 400 may then simply wheel or otherwise move holding stations 202A into the workspace 110A, and the robot 100A may detect the objects in the holding station 202A, determine the object(s) positions, and perform the tasks on the object(s). Human collaborators 400 may then remove the holding stations 202A with processed objects 200A and place new holding stations 202A with unprocessed objects. In some embodiments, the human collaborators 400 may place the holding stations 202A anywhere within the workspace 110A of the robot.

To perform task B, Robot B may be configured to move objects 200B from holding stations 202B to pick/place locations 212B disposed on workbenches 210B, Human collaborators 400 may then remove the objects 200B from the pick/place locations, perform operations on the objects 200B, and replace them into the pick/place locations 212B. The robot 100B may be configured to move the processed object 200B back into the holding stations 202B. In some embodiments, the human collaborator may signal that the object 200B is ready to be placed back in the holding station 202B (e.g. with a button). In some embodiments, the robot 100B may be configured to automatically detect when an object 200B has been replaced into the pick/place location 212B and move the object back into the holding station 202B when replacement is detected. In some embodiments, the objects 200B may include targets configured to be imaged by first and/or second imaging systems of robot 100B in order to allow the robot 100B to determine the position of the object 200B relative to the end effector 108B (e.g. if human collaborators 400 place objects 200B in pick/place locations 212B imprecisely).

If there no/reduced demand for task B, robot 100B may be repositioned such that at least one processing station 204A and at least one holding station 206A is disposed around robot 100B, and robot 100B may be commanded to perform task A. Robot B may then detect presence and positions of stations/other components associated with task A in its workspace, and perform task A on these objects. While the above embodiments only show two robots performing two different tasks, any number of robots performing any number of tasks is contemplated. Each robot 100 may therefore be configured to “position and play”, where each robot 100 may be repositioned and controlled to perform different tasks depending on demand, without needing to manually reteach the robot different positions of objects/stations.

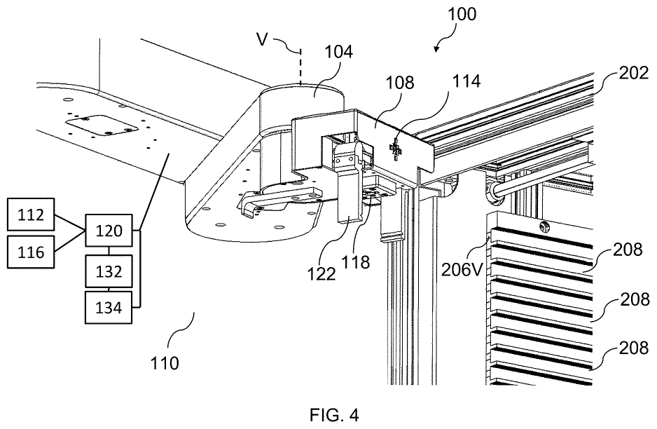

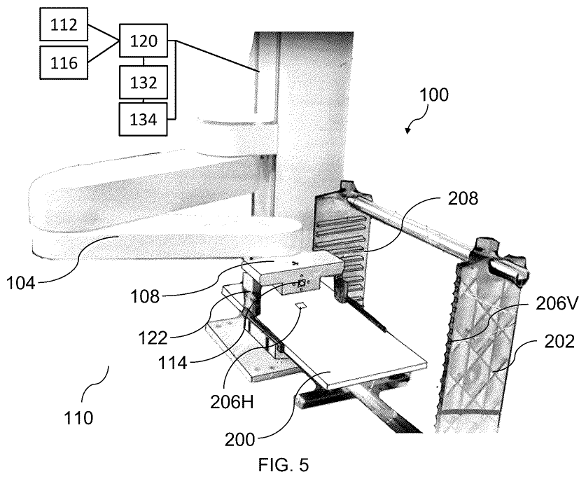

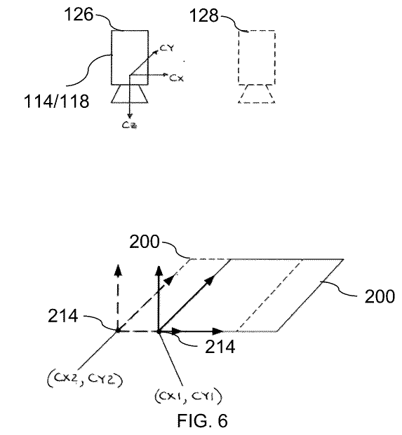

FIGS. 4 and 5 show an upper perspective view and lower perspective view, respectively, of an illustrative robot 100 that incorporates one or more inventive features. As mentioned above, the imagers of the first and second imaging systems 112 and 116 may be disposed at any suitable locations which allow for proper operation of the imaging systems 112 and 116. For instance, in some embodiments, the first imager is detached from the robot arm and disposed outside of the workspace (e.g. above the workspace, to a side of the workspace, etc.). In some embodiments, as seen in FIGS. 4 and 5, the first imager 114 is disposed on the end effector 108, e.g., with a horizontally oriented imaging field of view. Such a forward-facing first imager 114 may allow for presence detection and/or three-dimensional position determination even when an object 200 is gripped by grippers 122, as seen in FIG. 5. Such a configuration may be desirable, for instance if collaborators were to move a holding station 202 before the robot 100 has placed the object 200 in the receptacle 208. In such a scenario, the controller 102 could control the first imaging system 112 to detect the lack of presence of the holding station, and perform remedial actions (e.g. pause operation until the holding station 202 is replaced, alert human collaborators, etc.) rather than simply placing the object 200 where the receptacle 208 “should be”, and dropping to object 200 onto the floor.

When the first imager 114 is disposed on the end effector 108, a field of view of the first imager 114 may not be sufficient to view the entire workspace 110 at once. Therefore, when imaging the workspace 110 to detect presence of objects/other components, the controller 120 may control the robot arm 104 to move the end effector 108 to different positions within the workspace 110 to allow the first imager 114 to view the entire workspace 110. For instance, the end effector may be rotated 360° about an end effector vertical axis V in order to allow a forward facing first imager to view the entire workspace.

In some embodiments, as seen in FIG. 4, second imager 118 may be disposed on a bottom of end effector 108, such that second imager 118 may capture images in a direction approximately orthogonal to the direction that first imager 114 is configured to capture images in. Such a configuration may allow for the second imager 114 to capture stereo images of targets 206H disposed on horizontal surfaces, such as on top surfaces of object 200, as seen in FIG. 5.

As discussed above, in some embodiments, the controller 120 may be configured to detect presence of objects/components in the workspace 110 and determine the three-dimensional position of the objects/components relative to the end effector 108 using either the first imaging system 112 or the second imaging system 116. Such a configuration may be desirable, for instance, when the imagers 114 and 118 are mounted to the end effector of a SCARA robot arm, as the end effector of a SCARA robot arm may only rotate about vertical axis V, and thus may not be tilted about a horizontal axis. In such a configuration, the imager 114 of the first imaging system 112 may be disposed on a front of the end effector and configured to capture images in a horizontal direction and the imager 118 of the second imaging system may be disposed on the bottom of the end effector and configured to capture images in a vertical direction, such that the imagers of the first and second imaging systems have non-overlapping fields of view. The controller 120 may control the first imaging system to detect and determine three dimensional positions of objects/components with targets disposed on vertical surfaces (e.g. targets 206V in FIGS. 4 and 5), and the controller may control the second imaging system to detect and determine three-dimensional positions of objects/components with targets disposed on horizontal surfaces (e.g. target 206H in FIG. 5).

Such a configuration may allow for presence detection and relative position determination even when an object is being manipulated by the end effector 108. For instance, as discussed above, disposing first imager 114 on a front of the end effector 108 may allow the first imager to image the workspace to perform presence detection even if the robot 100 is currently gripping an object. If the first imaging system 112 is also configured for relative position determination, the controller 120 may be configured to sense if object holding station 202 has been moved (e.g. jostled by a collaborator), and to obtain stereo images of vertical targets 206V with first imager 114 in order to determine the new position of holding station 202 and/or receptacles 208 relative to the end effector, and control the robot arm 104 to place the object in the repositioned object receptacle 208.

The controller may use any suitable technique to obtain stereo images of the target 200 and to determine the position of target 200 relative to the end effector. For instance, in some embodiments, as seen in FIG. 6, the controller may control the position of imager 114/118 to obtain the stereo images. The imager 114/118 may be moved to a first position 126 and controlled to obtain a first image of the target 200, and then moved to a second position 128 to obtain a second image of the target 200. The controller may use the stereo images to determine the position of target 206 relative to the end effector 108 using any suitable technique. For instance, as seen in FIG. 6, the controller 120 may identify a two-dimensional pixel value CX1, CY1 of a portion 214 of target 200 (e.g. a corner of target 200) in the first image and a two-dimensional pixel value CX2, CY2 of that same portion 214 of target 200 in the second image using any suitable image analysis technique. The controller may then employ a stereoscopic imager model to estimate the three-dimensional position of the target 200 relative to the imager 114/118 based on the differences between CX 1 and CX 2, and the differences between CY 1 and CY2. The controller may then determine the three-dimensional position of the end effector relative to the object/component based on the estimated position of the imager 114/118 relative to the target 200, a predetermined position of the target relative to the object/component, and a predetermined position of the end effector relative to the imager 116/118.

While the above embodiments disclose first and second imaging systems with a single imager, in some embodiments, the first imaging system 112 and/or the second imaging system 114 may each include a pair of imagers. One imager in the pair of imagers may be disposed at first position 126, and the other imager in the pair of imagers may be disposed at second position 128. In some embodiments, the second imaging system 116 includes the second imager disposed at first position 126 and a third imager disposed adjacent to the second imager on the end effector at second position 128. The second and third imagers may be controlled to simultaneously image the target from positions 126 and 128 to obtain the stereo images for relative position determination to obtain the set of stereo images 127 and 129.

While the above embodiments disclose a robot with multiple imaging systems, in some embodiments, the robot may include a single imaging system, and the controller may be configured to control the single imaging system to detect presence of objects/components in the workspace and determine the position of the end effector relative to the objects/components using the techniques described above. Such a single imaging system may be used, for instance, on a gantry robot.

While the above embodiment discloses the robot arm performing tasks on a sample holder in a life sciences environment, it is contemplated that robot 100 may be configured to operate in any suitable work environment any perform tasks on any suitable object. For instance, the robot may be employed in a warehouse environment, a manufacturing plant (e.g. automotive, aerospace, electronics, semiconductor, etc.) or any other suitable environment. Objects 200 may be printed circuit boards, warehouse goods/containers, automotive parts, aerospace parts, electronic components, semiconductor wafers, or any other suitable object. The robot may be configured to perform any suitable tasks on such objects, such as milling, welding, soldering, etc.

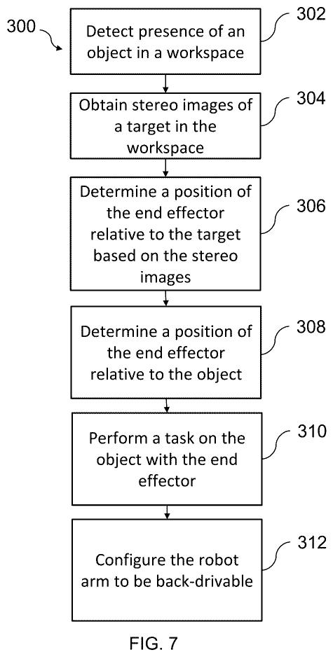

FIG. 7 shows a method 300 of operating a robot which incorporates one or more inventive features. At 302, the robot may detect the presence of an object in the workspace of the robot. Such presence detection may be performed using any suitable technique, such a as via the imaging system(s) discussed above. At 304, the robot may obtain stereo images of a target in the workspace. Such stereo images may be obtained via the same imaging system as the imaging system used for presence detection, may be obtained via a separate imaging system as discussed above, or via any other suitable technique. If an imaging system is used to obtain the stereo images, the imaging system may obtain the stereo images by imagining the target from multiple positions with a single imager, or may obtain the stereo images simultaneously with multiple imagers. The target may be associated with the object (e.g. disposed on the object, disposed on a receptacle holding the object, disposed on holding station and/or processing station, etc.). At 306, the robot may determine a position of the end effector of the robot relative to the target based on the stereo images. At 308, the robot may determine a position of the end effector relative to the object. At 310, the robot may perform tasks on the object. Such tasks may involve gripping the object with a gripper disposed on the end effector, manipulating the object's position, performing operations on the object (e.g. soldering, heating, stirring, performing tests, etc.), or any other suitable task. At 312, the robot arm of the robot may be configured to be back-drivable. Such back-drivability may be used for any suitable purposes, such as allowing human collaborators to alter the robot arm's controlled trajectory, or ensuring proper “fit-up” between the object and a receptacle for holding the object.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A robot comprising:
an articulated robot arm configured to be back-driven by force applied by a human or a mating operation in a workspace of the robot arm;
an end effector disposed on the robot arm, the end effector comprising a gripper configured to grip an object;
a first imaging system comprising a first imager configured to capture images in a first direction;
a second imaging system comprising a second imager configured to capture images in a second direction; and
a controller configured to:
control either the first imager or the second imager to obtain a set of stereo images of a target disposed in the workspace;
determine a position of the end effector relative to the target based on images of the target, wherein the images include only the set of stereo images obtained by the first imager or the second imager;
determine a position of the end effector relative to the object based at least in part on the determined position of the end effector relative to the target and on a position of the target relative to the object; and
control robot motion based on the determined position of the end effector relative to the object using images obtained only by the imager which obtained the set of stereo images.

2. The robot of claim 1, wherein the object is one of the following: a sample holder, a life sciences sample tray, a life sciences microplate, an individual life sciences sample tube held in a tray or microplate, a piece of life sciences labware, or a printed circuit board assembly.

3. The robot of claim 1, wherein one of the first and second imagers is configured to capture images in a horizontal direction and the other of the first and second images is configured to capture images in a vertical direction.

4. The robot of claim 1, wherein the first imager and the second imager are disposed on the end effector.

5. The robot of claim 1, wherein the workspace comprises a holding station and a processing station, and the robot is configured to move the object between the holding station and the processing station.

6. The robot of claim 5, further comprising a movable base configured for movement along a floor or other surface, wherein the robot arm is disposed on the base.

7. The robot of claim 6, wherein at least one of the holding station and the processing station are configured to be movable relative to the base.

8. The robot of claim 5, further comprising a receptacle disposed on the holding station and configured to receive the object, wherein the robot is configured to remove the object from the receptacle and place the object in the receptacle, wherein the robot arm is configured to be back-driven by force resulting from contact between the object and the receptacle as the robot removes or places the object in the receptacle.

9. The robot of claim 8, wherein the receptacle is a first receptacle of a plurality of receptacles disposed on the holding station, and wherein each receptacle is configured to slidingly receive an object.

10. The robot of claim 5, wherein the robot is configured to perform at least one task on the object at the processing station.

11. The robot of claim 1, wherein the first imaging system and second imaging system are selectively attachable to the robot.

12. The robot of claim 1, wherein the first imager and/or the second imager each include a single camera.

13. The robot of claim 12, wherein the first imager and/or the second imager are configured to obtain stereo images of the target by imaging the target from multiple positions.

14. The robot of claim 1, wherein the first and second imagers have non-overlapping fields of view.

15. The robot of claim 1, wherein the target is disposed on the object.

16. A method of controlling a robot comprising an articulated robot arm and a gripper disposed on an end effector of the robot arm, the method comprising:
controlling a first imager or a second imager to obtain a set of stereo images of a target disposed in the workspace, the first imager pointing in a different direction than the second imager;
determining a position of the end effector relative to the target based on images of the target, the images including only the set of stereo images obtained by the first imager or the second imager;
determining a position of the end effector relative to an object based at least in part on the determined position of the end effector relative to the target and on a position of the target relative to the object; and
controlling motion of the robot based on the determined position of the end effector relative to the object using images obtained only by the imager which obtained the set of stereo images;
wherein the robot arm is configured to be back-driven in response to a force applied by a human or a mating operation in the workspace.

17. The method of claim 16, wherein the first imager and the second imager are disposed on the end effector, and wherein controlling the first imager or the second imager to obtain the set of stereo images of the target in the workspace comprises moving the end effector to a first position, capturing a first image of the target, moving the end effector to a second position, and capturing a second image of the target.

18. The method of claim 16, further comprising gripping the object with the gripper and moving the object between a holding station and a processing station.

19. The method of claim 18, further comprising back-driving the robot arm in response to a force resulting from contact between the object and a receptacle disposed on the holding station.

20. The method of claim 16, further comprising moving a base on which the robot arm is mounted across a floor or other surface.
